(19) United States
(12) Patent Application Publication
(10) Pub. No.: US 2026/0266244 A1
(43) Pub. Date: Sep. 10, 2026

(54) VALVE SET FOR CONDUCTING AND CONDITIONING A GASEOUS FUEL

(71) Applicant: Liebherr-Components Deggendorf GmbH, Deggendorf (DE)

(72) Inventors: Mario D’ONOFRIO, La Tour de Trême (CH); Sebastien BOZZOLO, Chatel Saint Denis (CH); Myriam ROSSIER, Autigny (CH); Richard PIRKL, Regensburg (DE)

(21) Appl. No.: 19/489,234

(22) PCT Filed: May 6, 2024
(86) PCT No.: PCT/EP2024/062428

§ 371 Date: Dec. 1, 2025

(30) Foreign Application Priority Data
Jun. 1, 2023 (DE) 10 2023 114 356.5

(51) Int. Cl. F02M 21/02

(52) U.S. Cl. CPC F02M 21/0239; F02M 21/0206; F02M 21/0242

(57) ABSTRACT

The present invention relates to a valve set for conducting and conditioning a gaseous fuel, comprising: an inlet for receiving a pressurised gaseous fuel from a fuel storage tank, an outlet for forwarding the pressurised gaseous fuel to a fuel injector, a shut-off valve fluidically connected to the inlet for selectively blocking or allowing passage of the gaseous fuel from the inlet to the outlet, a gas metering valve fluidically connected in series with the shut-off valve for regulating a flow of the gaseous fuel that has flowed in via the inlet and directing it to the outlet, and a vent valve which, in an open state, lowers the pressure prevailing at the outlet to a predetermined level. In a de-energised state, the shut-off valve is closed and blocking a fluid line, and the vent valve is open.

### CROSS REFERENCE TO RELATED APPLICATIONS

The present application is a U.S. National Phase of International Application No. PCT/EP2024/062428 entitled “VALVE SET FOR CONDUCTING AND CONDITIONING A GASEOUS FUEL,” and filed on May 6, 2024. International Application No. PCT/EP2024/062428 claims priority to German Patent Application No. 10 2023 114 356.5 filed on Jun. 1, 2023. The entire contents of each of the above-listed applications are hereby incorporated by reference for all purposes.

### TECHNICAL FIELD

The present invention relates to a valve set for conducting and conditioning a gaseous fuel and to a device for injecting a gaseous fuel with such a valve set.

### BACKGROUND AND SUMMARY

To protect the environment, there are increasing efforts to develop alternative fuel strategies that focus on a reduction of CO₂ emissions. In this context, in particular a further development of the previous internal combustion engine has come into focus, in which, for example, the diesel fuel used is replaced by “green” fuels, for example H₂ in the gas phase. For rapid dissemination and rapid acceptance, it is necessary that these new engines, in comparison with the conventional engine generation (for example diesel engines), deliver the same or better performance, both in stationary operation and in transient/dynamic operation.

Conventional internal combustion engines have in recent years been dominated mainly by liquid fuels from gasoline (mainly gasoline and diesel). Many tests have been carried out in the field of internal combustion engines with gaseous fuels such as natural gas (CNG) or liquefied petroleum gas (LPG), including their associated injection systems. In these cases, however, in series production of internal combustion engines an indirect multi-point injection system (MPI) is used, in which the gas is injected at low pressure, typically <10 bar, into the intake manifold of the engine. In such a technology, the injection pressure is almost constant and does not require rapid pressure changes.

New research on internal combustion engines that are supplied with gaseous fuels (CNG or H₂), with the aim of optimizing engine performance, however shows that direct injection technology (that is, the direct feeding of the gaseous fuel into the combustion chamber of an engine cylinder) brings advantages in terms of performance and efficiency. In order to enable precise metering of the desired quantity of fuel, the injection system requires highly dynamic pressure control capabilities which were not required in MPI technology, since there the gaseous fuel is continuously supplied to the injection nozzles at a constant pressure of about 10 bar or less.

The present invention proposes an effective solution in order to provide an improved implementation of the pressure dynamics and pressure control both for PFI (=intake-manifold injection) and for direct injection, in which at the same time essential safety functions are also integrated. Owing to the more compact design, the installation space, which is in any case only available to a limited extent, is utilized better and the number of required components is reduced.

Since injection of gas (typically H₂) is currently a technology that is not yet used in series production, no solutions are known on the market that satisfy both the requirements with regard to the dynamics of pressure control and the integration of essential safety features.

An implementation known from the prior art corresponds in its basic design to the illustration in FIG. 1. Here, the pressure control is carried out by two mutually different components. Whereas it was previously customary to provide a single pressure control valve between the gas storage tank and the distribution unit, which is capable of converting the gas pressure provided by the gas storage tank, depending on the requirement, into a specific, variable outlet pressure, an approach according to the prior art is now pursued.

Thus it is provided to use a pressure regulating unit and a flow control valve arranged downstream thereof. In this case, first of all the gaseous fuel (or fuel present in the storage tank also in liquid form), which is compressed in a gas storage tank at a very high pressure (up to 350 bar), is reduced by the pressure regulating unit to a stationary, constant intermediate pressure level (for example in the range from 50 to 60 bar), and only downstream thereof it is set, by means of the flow control valve, to the actually requested pressure in the distribution unit (for example to a value in the range from 10-60 bar).

The advantage resulting from the inventive division of the function into two different components (pressure regulating unit and flow control valve) lies in the fact that the downstream volume (regulation volume) can be reduced by a suitable arrangement of the flow control valve. This then leads to a reduction of the deviations between a desired target pressure value in the distribution unit and a prevailing actual pressure value, since a more rapid change of the pressure value prevailing in the distribution unit is possible.

The value of the pressure that feeds the injection nozzles is the result of the flow equilibrium between the volumetric flow that enters the control volume (rail+lines+injection nozzles) and the flow that must leave the control volume (engine demands). The time for emptying the regulation volume is proportional to the size of the regulation volume. By minimizing the regulation volume, the response time of the system is also minimized, so that the pressure control can take place very quickly.

A disadvantage of the implementation known from FIG. 1 is that safe operation of such injection requires a multiplicity of distributed components and the knowledge about the state of the gaseous fuel for even more precise injection via the at least one fuel injector is in need of improvement.

Achievement of an improved implementation in this regard is accomplished by a device with features described herein.

According to the invention, a valve set for conducting and conditioning a gaseous fuel, in particular hydrogen, is provided, which comprises an inlet for receiving a gaseous fuel under pressure from a fuel storage tank, an outlet for forwarding a gaseous fuel under pressure to a fuel injector, a shut-off valve which is fluidically connected to the inlet and serves to selectively block or enable forwarding of the gaseous fuel flowing in from the inlet to the outlet, a gas metering valve which is fluidically connected in series with the shut-off valve and serves to regulate a flow of the gaseous fuel that has flowed in via the inlet (preferably with regard to pressure and quantity) and to direct it to the outlet, and a vent valve which serves, in an open state, to lower the pressure prevailing at the outlet to a predetermined level, in particular to depressurize the outlet, the shut-off valve being closed in a de-energized state and blocking a fluid line, and the vent valve being open in a de-energized state. Preferably it can be provided that the gas metering valve is closed in a de-energized state.

The valve set according to the invention unites a multiplicity of functions that were previously arranged in a distributed manner and thus represents a significant simplification in the construction of a fuel injection system for gaseous fuel.

In addition to the gas metering valve which sets or regulates the flow of the gaseous fuel in the direction of the outlet (towards the fuel injector arranged downstream), the valve set contains a shut-off valve and a vent valve. In this case it is provided that, in a de-energized state, the shut-off valve separates a fluid connection from the inlet of the valve set (which is usually connected to a tank for the gaseous fuel) to components provided downstream thereof, whereas in a de-energized state the vent valve lowers an outlet of the valve set (which is usually connected to a distribution unit/rail or directly to a fuel injector) to a predetermined level, for example in that the outlet is coupled via a vent line to the ambient pressure.

In this way, in addition to the flow control of the gaseous fuel carried out by the gas metering valve, it is ensured that, in the event of a sudden failure of the power supply leading to the valve set, the valve set ensures that a distribution unit/rail fluidically connected downstream, or a fuel injector connected thereto, is vented immediately. In view of the very high pressures prevailing there, this represents a significant improvement in safety, which can moreover be achieved with a single component implemented by the valve set.

The shut-off valve can be arranged at the inlet of the valve set and serves to maintain safety in the event of deactivation or an emergency stop of an engine which is equipped with a fuel supply system that comprises the valve set. The shut-off valve thus interrupts the fluid connection to a fuel tank arranged upstream and enables venting of the system downstream of the valve set. It is advantageous if this shut-off valve is leak-free over its entire service life, since only then is reliable shut-off of the fuel tank ensured.

The gas metering valve can be a proportional volumetric flow control valve whose main function is to regulate the downstream flow of the gaseous fuel. Typically, a distribution unit/rail or a fuel injector is connected directly downstream to the valve set, which is acted upon by the gaseous fuel conditioned by the gas metering valve.

The vent valve is fluidically coupled to the outlet of the valve set and serves to vent the gaseous fuel from a region downstream of the valve set. For this purpose, it has a vent line which, as required, is fluidically connected to the outlet of the valve set in order to lower the high pressure prevailing there to a predetermined level. It can be provided in particular that the vent line is connected to the ambient air, so that, upon fluidically connecting the vent line to the outlet of the valve set, the pressure prevailing at the outlet is lowered to the ambient pressure. The venting of the components arranged downstream at the outlet of the valve set is required in terms of safety and is carried out upon each stopping of an engine which has a fuel supply device with such a valve set. Naturally, venting also takes place if an emergency stop of such an engine occurs.

According to an optional development of the present invention, it can be provided that the vent valve is fluidically connected to the outlet via a line which runs inside the valve set and/or outside the valve set.

Accordingly, in order to achieve the advantages of the invention, it is irrelevant whether the valve set has in its interior a line which fluidically connects the vent valve to the outlet or whether the outlet is fluidically connected to the vent valve via a connecting element to be arranged externally on the valve set. It can therefore also be provided that the vent valve has a connection arranged in the valve set which can be connected to the outlet via an external connecting line.

According to a further optional development of the present invention, it can be provided that the valve set further comprises a pressure and/or temperature sensor for detecting the pressure and/or the temperature of the gaseous fuel in an inlet region of the valve set, in particular at the inlet. This pressure and/or temperature sensor serves to detect the pressure and the temperature in an inlet region of the valve set in order to determine the quantity and the pressure of the gaseous fuel to be output. As a rule, an engine control unit (or an electronic control unit) is used which receives and processes the detected values for the pressure and the temperature in the inlet region of the valve set and, on the basis of this, correspondingly actuates the gas metering valve. In addition, by detecting the pressure and/or temperature values at the inlet region of the valve set, the state of the system and also the exceeding of safety-critical regions can be monitored. Thus, for example, in the case of unusually low pressure values, it can be concluded that the pressure regulating valve, which is typically arranged upstream of the valve set and brings the pressure, which falls with the filling level of the fuel tank, to a uniform level, is defective.

According to a further advantageous implementation of the present invention, it can be provided that the valve set further comprises a pressure and/or temperature sensor for detecting the pressure and/or the temperature of the gaseous fuel in an outlet region of the valve set, in particular at the outlet.

By detecting the pressure and/or the temperature at an outlet region of the valve set, conclusions can be drawn about the fault-free functioning of the valve set.

Furthermore, in the case of direct connection of a distribution unit arranged downstream, for example a rail, temperature and/or pressure sensors that are typically present there can be dispensed with, since the values determined there would generally coincide with those at the outlet of the valve set. This reduces the number of necessary components, since it is no longer necessary to provide corresponding sensors in the distribution unit (or the rail), whereby a corresponding separate wiring to precisely those sensors is also dispensable. It is now only necessary to connect the valve set with its sensors arranged therein, whereby the effort for cabling and assembly is significantly reduced.

Naturally, this is also advantageous if the at least one fuel injector arranged downstream of the valve set is connected directly to the valve set without the presence of an intermediate distribution unit (or rail). Thus, there are implementations in which a separate connecting line to the valve set is provided for each of the plurality of fuel injectors, so that each of the plurality of fuel injectors can be supplied with a quantity of gaseous fuel matched to it. A common distribution unit, to which a plurality of fuel injectors are connected, then no longer exists. For this implementation too it is advantageous to know the pressure and the temperature of the gaseous fuel which is discharged for outflow via the respective fuel injector, since the opening time of a respective fuel injector can advantageously be adjusted on the basis of this.

According to a further advantageous modification of the present invention, it can be provided that the valve set further comprises a safety valve which is fluidically connected on the inlet side to the inlet and on the outlet side to a low-pressure side or the vent line of the vent valve and serves, upon exceeding of a pressure threshold value on the inlet side, to establish a fluid connection between the inlet side and the outlet side in order to lower the pressure on the inlet side.

Typically, this safety valve may be a mechanical relief valve in order to prevent an excessively high pressure at the inlet of the valve set which could lead to damage to the valve set or to components adjoining it. In order to exclude such a situation, the safety valve connects the inlet to the vent line of the vent valve if the pressure at the inlet should exceed a predetermined pressure threshold value.

According to the invention it can be provided that all valves are mounted on a common base and arranged rigidly relative to one another. The valve set is thus a single component which has a plurality of valves and the actuation of which can be carried out via a common control connection. Therefore, an electronic control unit (for example an engine control unit) no longer has to be wired separately to each of the plurality of valves present in the valve set, but it is sufficient that the wiring is made to the valve set. This leads to a significant reduction in the installation effort, since valves that were previously typically arranged in a distributed manner are now combined centrally in the valve set.

According to the invention, it can further be provided that the vent valve is fluidically connected on the inlet side to the outlet of the valve set and fluidically connected on the outlet side to a low-pressure region, in particular to the ambient air. The vent valve thus serves to lower a pressure at the outlet of the valve set, as required, to a certain pressure value. Thus, in a fuel supply system it is typically necessary to evacuate components that are under high pressure relatively quickly in the event of an emergency stop or deactivation of the fuel supply line so that they no longer pose a hazard. As a rule, maintenance personnel or the like assume that a rest state or a deactivated engine no longer contains components which are under pressure and from which a hazard can emanate. This would, however, be the case if, when attempting repair of the valve set, it were found that it was still under high pressure.

The invention further relates to a device for injecting a gaseous fuel, in particular hydrogen, which comprises a valve set according to one of the preceding variants, at least one fuel injector which is arranged downstream of the valve set and serves to introduce the gaseous fuel into a combustion chamber, and an electronic control unit which is designed to actuate the valves of the valve set, preferably as a function of at least one temperature and/or pressure value of the gaseous fuel detected in the valve set in the inlet region and/or in the outlet region.

It will thus be apparent that the valve set according to the invention can also be used in combination with a device for injecting a gaseous fuel, since the valve set particularly fully exploits its advantages therein. The valve set according to the invention not only serves to condition the fuel for the components arranged downstream (distribution unit/rail and fuel injector), but also contains essential safety functions, for example the vent valve, whereby the entire device for injecting a gaseous fuel is significantly simplified and improved.

Furthermore, it can be provided that the device comprises a distribution unit, in particular a rail, which is fluidically connected to the at least one fuel injector for introducing the gaseous fuel into a combustion chamber, preferably the distribution unit being arranged downstream of the valve set and the at least one fuel injector being arranged downstream of the distribution unit. The distribution unit serves to receive a gaseous fuel under a certain pressure so that a plurality of fuel injectors connected to the distribution unit can introduce this into a combustion chamber.

If a plurality of fuel injectors or all fuel injectors of an engine have a connection to precisely that distribution unit, this is also referred to as a common rail.

According to the present invention, it can furthermore be provided that the distribution unit branches off directly from the valve set without the presence of a connecting line arranged between the distribution unit and the valve set. A connecting line which connects the outlet of the valve set to a distribution unit does not necessarily have to be present.

Alternatively, however, according to the invention it is also possible for the distribution unit to be connected to the valve set via a connecting line which is rigid or flexible in design. By arranging a connecting line between the distribution unit and the valve set, an optimum arrangement position can be found for both the distribution unit and the valve set, which do not have to be in immediate proximity to one another.

The present invention furthermore relates to an engine with a device according to one of the preceding variants, in particular an internal combustion engine, fuel cell or gas turbine. Even if the invention is explained primarily with reference to a hydrogen internal combustion engine, the possible uses of the present invention are not restricted to this. The valve set or the device for injecting a gaseous fuel can also be used in connection with a gas turbine or a fuel cell.

Furthermore, according to an optional modification it can be provided that the valve set is arranged no further than 2 m from the center of gravity of the engine, preferably the valve set being fastened to an engine housing.

This advantageously results in the fact that the fluid space present downstream of the valve set, which is to be acted upon with a gaseous fuel, has a limited volume so that it can be regulated well. If the valve set is arranged further away from this, the control volume present downstream of the valve set becomes too large, so that these are no longer feasible, in particular in the case of relatively high changes in demand with regard to the pressure of the gaseous fuel.

According to an advantageous development of the present invention, it can be provided that the engine is an internal combustion engine which uses gaseous hydrogen as fuel for driving the engine, which is supplied to the inlet of the valve set at a predetermined pressure level.

As a rule, the gaseous fuel is converted into the gaseous form only after being removed from a fuel tank, since storage in the liquid state takes up less space. Regardless of the form in which the fuel is stored, the problem arises in the case of the fuel tank that the pressure of the fuel stored therein also drops with a falling fuel level. In order not to have to work with a varying pressure level of the fuel, a pressure regulating valve is typically connected downstream of the fuel tank, which keeps the fuel taken from the fuel tank at a constant pressure level. This simplifies the further processing of the fuel since the downstream components do not have to work with a varying pressure level of the gaseous fuel.

The invention further relates to a working machine with a valve set according to one of the preceding variants, a device according to one of the preceding variants and/or an engine according to one of the preceding variants.

### BRIEF DESCRIPTION OF THE FIGURES

Further features, details and advantages of the invention will become apparent from the following description of the figures. In the drawings:

FIG. 1: a schematic illustration of a device known from the prior art for injecting a gaseous fuel,

FIG. 2: a schematic illustration of a valve set according to the invention for injecting a gaseous fuel,

FIG. 3: a schematic illustration of a valve set according to the invention for injecting a gaseous fuel,

FIG. 4: a schematic illustration of an embodiment of a device according to the invention for injecting a gaseous fuel,

FIG. 5: a schematic illustration of a further embodiment of a device according to the invention for injecting a gaseous fuel,

FIG. 6: a schematic illustration of a further embodiment of a device according to the invention for injecting a gaseous fuel, and

FIG. 7: a schematic illustration of a further embodiment of a device according to the invention for injecting a gaseous fuel.

### DETAILED DESCRIPTION

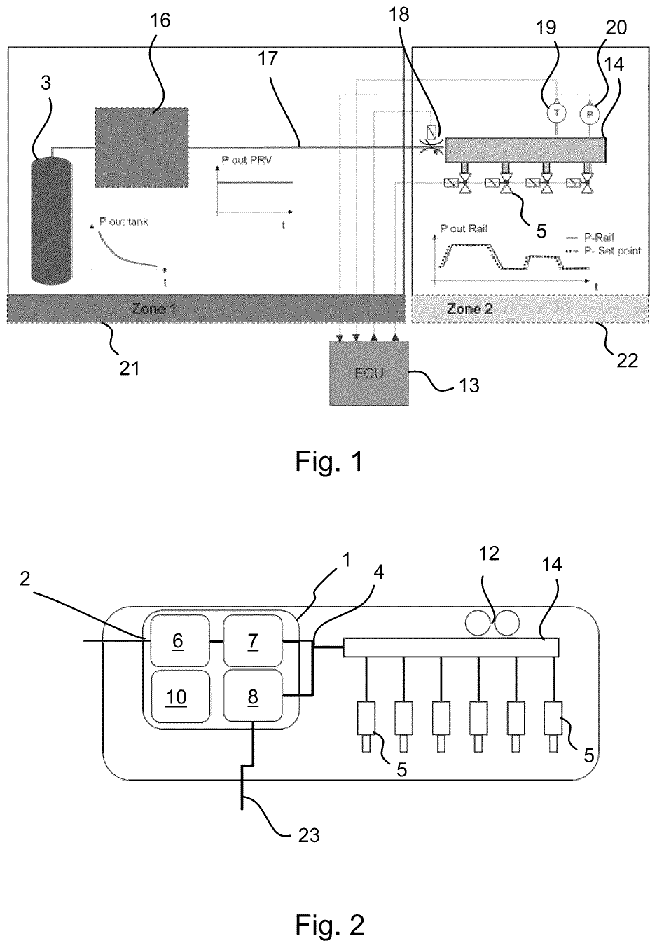

FIG. 1 shows a device for supplying a gaseous fuel from the prior art. Starting from a storage tank 3 or tank, the fuel present in gaseous form at the outlet of the storage tank 3 is introduced into the distribution unit 14 so that the injectors 5 connected thereto can output the gaseous fuel at a desired pressure level.

A pressure regulating unit 16 adjoins the outlet of the storage tank 3 and outputs the fuel at a constant, stationary pressure. This pressure is, for example, in the range of approximately 60 bar and thus significantly below the pressure level of approximately 350 bar prevailing in the storage tank 3. Downstream of the pressure regulating unit 16, a flow control valve 18 is connected via a fluid connection, the task of which, separate from the pressure regulating unit 16, is to generate the variable pressure levels to be set in the distribution unit 14.

To the right of the storage tank 3, the pressure P plotted over time t can be seen, which decreases with decreasing fill level of the storage tank 3. The pressure regulating unit 16 has the task of bringing the fuel originating from the storage tank 3 to a constant, stationary pressure level. The fuel at this constant, stationary pressure level is then conducted via the fluid connection to the flow control valve 18, which is typically arranged in the region of the distribution unit 14. As a result, the control volume which is to be acted upon with a variable pressure of fuel is reduced. Thus, implementations are conceivable in which, for example, the control volume can be reduced to the distribution unit 14 and the injectors 5 connected thereto. The flow control valve 18 is designed, starting from the constant, stationary outlet pressure of the pressure regulating unit 16, to output the desired variable pressure values which are to prevail in the distribution unit 14.

To the right of the pressure regulating unit 16, the outlet pressure level P over time t can be seen, which is supplied from the pressure regulating unit 16 via the fluid line to the flow control valve 18. The flow control valve 18 receives—independently of a fill level of the storage tank 3—a constant pressure level of the fuel, from which the desired target pressure values are set.

Below the distribution unit 14, a graphical representation is shown which reproduces the pressure P prevailing in the distribution unit 14 over time t. The continuous line of this representation describes the actual pressure of the fuel, whereas the dashed line indicates the target pressure value of the fuel.

Furthermore, it can be seen that the first zone 21, which defines the supply region of the fuel without load-dependent, variable pressure fluctuations, contains not only the storage tank 3 of the device, but also the pressure regulating unit 16 and a part of the fluid connection 17.

The second zone 22, which designates the components with the regulation volume to be controlled of a varying pressure and the quantity of the gaseous fuel, is smaller, since large parts of the fluid connection arranged upstream of the flow control valve 18 are acted upon with a constant, stationary pressure of the fuel. The small regulation volume also causes the improved response behavior of a varied pressure in the distribution unit 14.

The electronic control unit 13 is connected to a temperature sensor 19 which measures the temperature in the distribution unit 14. In addition, the electronic control unit 13 is also connected to a pressure sensor 20 which detects the pressure prevailing in the distribution unit 14. It can be provided that, depending on the pressure and/or temperature in the distribution unit 14, actuation of the flow control valve 18 and/or of the injectors 5 connected to the distribution unit 14 takes place.

The second zone 22 defines the engine compartment of a vehicle, whereas the first zone 21 describes the fuel supply region of a vehicle. By arranging the flow control valve 18 in or near the engine compartment and the pressure regulating unit 16 at a position remote from this, the advantages described above can be achieved.

FIG. 2 shows a schematic illustration of a valve set 1 according to the invention for injecting a gaseous fuel together with a distribution unit 14 arranged downstream thereof and at least one fuel injector 5. An inlet 2 of the valve set 1 can be seen, which serves to connect the fluid line from the pressure regulating valve 16. This inlet 2 is connected to a shut-off valve 6 which can selectively close or open the inlet 2 of the valve set 1 to components arranged downstream thereof. A gas metering valve 7 which serves to condition the gaseous fuel is connected in series with the shut-off valve via a connecting line. In addition, a vent valve 8 is provided in the valve set 1 which serves to selectively connect an outlet 4 of the valve set 1 to a low-pressure region in order to reduce a high pressure prevailing at the outlet 4. The low-pressure region, to which the vent valve 8 is connected via a vent line (or a low-pressure line), can also be embodied by the ambient pressure. Thus, upon actuating the vent valve 8, it can be provided that the pressure at the outlet 4 of the valve set 1 is lowered to the ambient pressure.

For the purposes of the present invention, it is irrelevant whether the vent valve is connected to the outlet 4 by a line running inside the valve set 1 or whether this takes place via a line provided outside the valve set 1. In FIG. 2, the externally running line is shown, whereas in subsequent figures of the present invention the implementation with a line running internally in the valve set is also shown.

Downstream of the valve set 1, a distribution unit 14 is arranged, from which at least one fuel injector branches off in order to introduce fuel into a combustion chamber of an internal combustion engine. In addition, a pressure and/or temperature sensor 12 is provided at the distribution unit 14 in order to detect the pressure and/or the temperature of the gaseous fuel present in the distribution unit 14. Analogously to FIG. 1, the value or values detected in this way are transmitted to an engine control unit 13 which, depending thereon, actuates the valve set 1 and the at least one fuel injector 5.

The valve set 1 further has a pressure and/or temperature sensor 10, which determines at the inlet region of the valve set 1 the pressure or the temperature of the gaseous fuel which is introduced at the inlet 2 of the valve set 1.

The connection between the valve set 1 and the downstream distribution unit 14 can be implemented by a flexible hose in order to decouple vibrations emanating from the engine compartment from the components arranged upstream, such as the pressure regulating unit 16 and the storage tank 3.

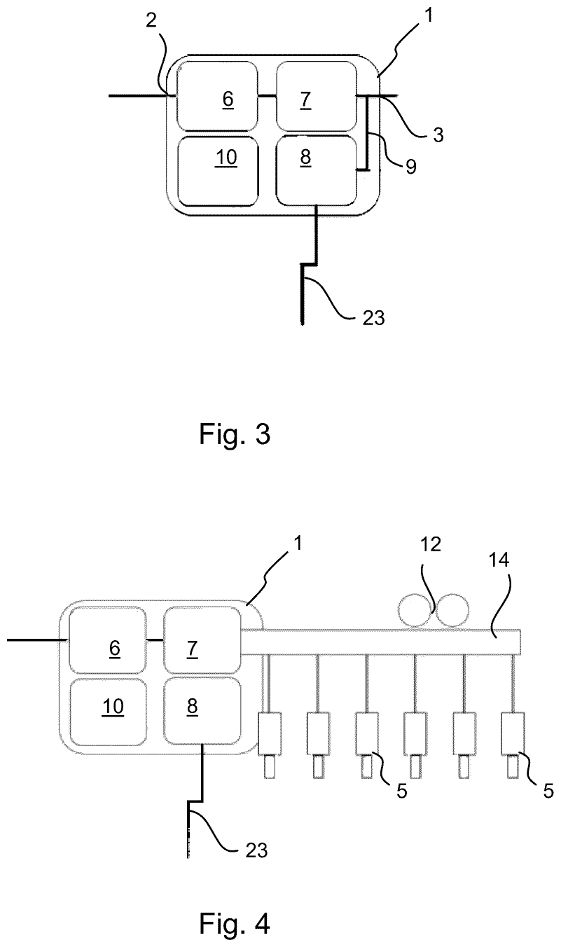

FIG. 3 shows a further embodiment of the present invention, in which the valve set 1 now, in deviation from the illustration in FIG. 2, has an internal line 9 which connects the vent valve 8 to the outlet 3 of the valve set 1.

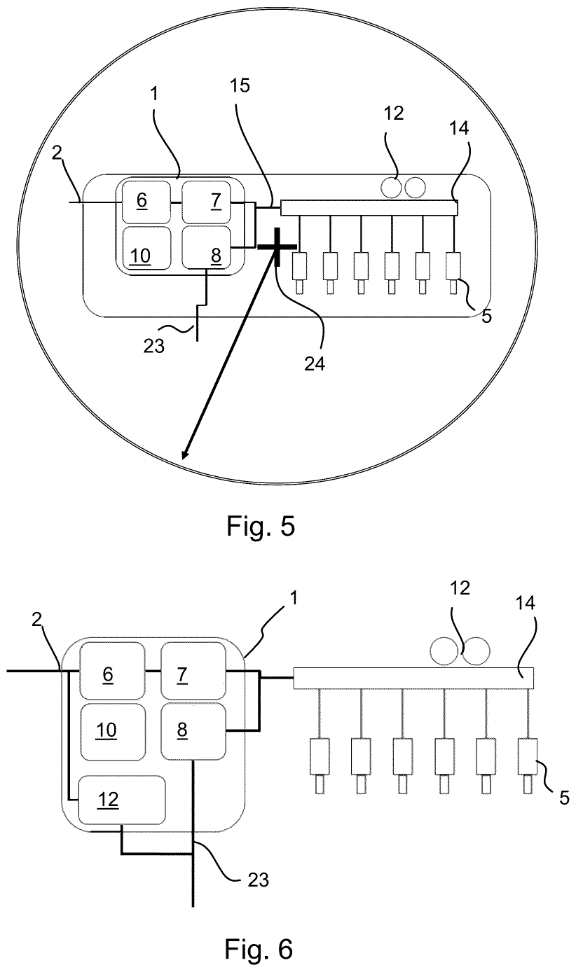

FIG. 4 shows a further embodiment of the present invention, in which, in a device for supplying a gaseous fuel into a combustion chamber of an internal combustion engine, the distribution unit 14 is arranged directly at the outlet of the valve set 1. It can be seen that no line is provided between the distribution unit 14 and the outlet 3 of the valve set 1 or the gas metering valve 7, so that the control volume to be regulated downstream of the valve set 1 is reduced and can be determined in a simple manner. For reasons of better clarity, the connection of the distribution unit 14 to the vent valve 8 is not shown. As already explained above, this can either be implemented in the interior of the valve set 1 or via a separate line on the exterior of the valve set 1.

FIG. 5 shows a further embodiment of a device according to the invention for supplying a gaseous fuel into a combustion chamber of an internal combustion engine, in which it is illustrated graphically that the valve set 1 is to be arranged in a certain spatial proximity to the engine. The reference numeral 24 denotes the center of gravity of such an engine, from which the valve set 1 may be arranged at a maximum distance of 2 m. If it is not, this leads to an unfavorably long connecting line between the valve set 1 and the distribution unit 14 or an injector 5, which increases the control volume and no longer sufficiently enables dynamic pressure control.

The circle shown in FIG. 5 with the radius indicated corresponds in reality to a sphere which defines the permissible arrangement space for the valve set 1. An arrangement within this sphere, i.e. at no more than 2 m from the center of gravity 24 of the engine, is considered to be particularly advantageous, since here a downstream control volume can still be regulated with high dynamics with regard to pressure changes of the gaseous fuel.

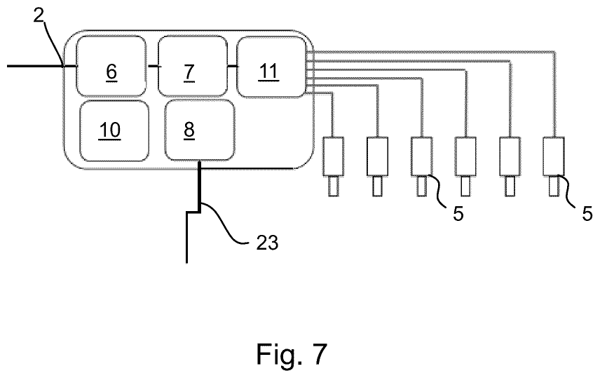

FIG. 6 shows a further embodiment of a valve set 1 according to the invention, in which, in addition to the components already discussed in more detail above, a safety valve 12, typically a mechanical safety valve, is arranged in the valve set in order to counteract a possible overload of pressure at the inlet 2. The safety valve 12 has the task, upon exceeding of a certain pressure threshold value at the inlet 2, of connecting the inlet 2 to the vent line 23 (which is coupled to a low-pressure region, for example the ambient pressure). As a result, the safety valve 12 ensures that the pressure at the inlet 2 of the valve set 1 does not exceed the predetermined pressure threshold value. It is thus ensured that the valve set 1 only operates in a pressure range for which it is designed.

FIG. 7 shows a further embodiment of the present invention, in which the valve set 1, in addition to the shut-off valve 6, the gas metering valve, the vent valve 8, the pressure and/or temperature sensor 10 at the inlet region, also has a further pressure and/or temperature sensor 11 at the outlet region.

In addition, the present implementation also does not have a distribution unit 14 arranged between the fuel injector 5 and the outlet 3 of the valve set 1. Rather, the plurality of fuel injectors 5 are connected to the valve set 1 via a respective fuel connecting line, so that the respective fuel quantity with the associated pressure for each of the plurality of fuel injectors 5 is output by the valve set 1. This can further reduce the control volume downstream of the valve set 1, resulting in an even better dynamic adjustability of the pressure of the gaseous fuel.

### LIST OF REFERENCE NUMERALS

1 valve set
2 inlet
3 fuel storage tank
4 outlet
5 fuel injector
6 shut-off valve
7 gas metering valve
8 vent valve
9 line
10 pressure and/or temperature sensor at the inlet
11 pressure and/or temperature sensor at the outlet
12 safety valve
13 electronic control unit
14 distribution unit/rail
15 connecting line between valve set and distribution unit
16 pressure regulating unit
17 fluid connection
18 flow control valve
19 temperature sensor
20 pressure sensor
21 zone 1
22 zone 2
23 vent line
24 center of gravity of the engine

1. A valve set for conducting and conditioning a gaseous fuel, comprising:
an inlet for receiving the gaseous fuel under pressure from a fuel storage tank,
an outlet for forwarding the gaseous fuel under pressure to a fuel injector,
a shut-off valve which is fluidically connected to the inlet and serves to selectively block or enable forwarding of the gaseous fuel flowing in from the inlet to the outlet,
a gas metering valve which is fluidically connected in series with the shut-off valve and serves to regulate a flow of the gaseous fuel flowing in via the inlet and to direct it to the outlet, and
a vent valve which serves, in an open state, to lower the pressure prevailing at the outlet to a predetermined level,
wherein the shut-off valve is closed in a de-energized state, and
wherein the vent valve is open in the de-energized state.

2. The valve set according to the preceding claim 1, wherein the vent valve is fluidically connected to the outlet via a line which runs inside the valve set and/or outside the valve set.

3. The valve set according to the preceding claim 1, further comprising a pressure and/or temperature sensor for detecting the pressure and/or the temperature of the gaseous fuel in an inlet region of the valve set.

4. The valve set according to the preceding claim 1, further comprising a pressure and/or temperature sensor for detecting the pressure and/or the temperature of the gaseous fuel in an outlet region of the valve set.

5. The valve set according to the preceding claim 1, further comprising a safety valve which is fluidically connected on the inlet side to the inlet and on the outlet side to a low-pressure side of the vent valve and serves, upon exceeding of a pressure threshold value on the inlet side, to establish a fluid connection between the inlet side and the outlet side in order to lower the pressure on the inlet side.

6. The valve set according to the preceding claim 1, wherein all valves are mounted on a common base and arranged rigidly relative to one another.

7. The valve set according to one of the preceding claim 1, wherein the vent valve is fluidically connected on the inlet side to the outlet and fluidically connected on the outlet side to a low-pressure region.

8. A device for injecting a gaseous fuel comprising:
the valve set according to one of the preceding claim 1,
at least one fuel injector which is arranged downstream of the valve set and serves to introduce the gaseous fuel into a combustion chamber, and
an electronic control unit which is designed to actuate the valves of the valve set.

9. The device according to claim 8, further comprising a distribution unit which is fluidically connected to the at least one fuel injector for introducing the gaseous fuel into the combustion chamber.

10. The device according to the preceding claim 9, wherein the distribution unit branches off directly from the valve set without the presence of a connecting line arranged between the distribution unit and the valve set.

11. The device according to the preceding claim 9, wherein the distribution unit is connected to the valve set via a connecting line which is rigid or flexible in design.

12. An engine with the device according to the preceding claim 8.

13. The engine according to the preceding claim 12, wherein the valve set is arranged no further than 2 m from the center of gravity of the engine.

14. The engine according to one of the preceding claim 12, wherein the engine is an internal combustion engine which uses gaseous hydrogen as fuel for driving the engine, which is supplied to the inlet of the valve set at a predetermined pressure level.

15. A working machine with the valve set according to the preceding claim 1.

16. The valve set according to claim 1, wherein the gaseous fuel is hydrogen.

17. The valve set according to claim 1, wherein the vent valve serves to depressurize the outlet in an open state.

18. The valve set according to claim 1, wherein the gas metering valve is closed in a de-energized state.

19. The valve set according to claim 3, wherein the pressure and/or temperature sensor detects the pressure and/or the temperature of the gaseous fuel at the inlet.

20. The valve set according to claim 4, wherein the pressure and/or temperature sensor detects the pressure and/or the temperature of the gaseous fuel at the outlet.
